(19) United States
(12) Patent Application Publication
(10) Pub. No.: US 2015/0077979 A1
(43) Pub. Date: Mar. 19, 2015

(54) Road Surface Lighting Apparatus

(71) Applicant: Richard A. NAMORS, Custer, MI (US)

(72) Inventor: Richard A. NAMORS, Custer, MI (US)

(21) Appl. No.: 14/488,281

(22) Filed: Sep. 16, 2014

Related U.S. Application Data
(60) Provisional application No. 61/878,215, filed on Sep. 16, 2013.

(51) Int. Cl. E01F 9/04; F21L 4/08

(52) U.S. Cl. CPC E01F 9/04; F21L 4/08
USPC 362/153.1

(57) ABSTRACT

A road surface lighting apparatus is used illuminate a large surface area of a road such as a highway or interstate. The apparatus includes a traffic barrier, a wide band lamp, solar panels, auxiliary electrical leads, and a horizontal conduit. The traffic barrier is used to situate and position the wide band lamp along the length of the road. The wide band lamp is designed to emit light in the form of an ellipsoid arc. The solar panels provide renewable electrical power to the wide band lamp, and the auxiliary electrical leads provide electrical power to the wide band lamp from an external source. The horizontal conduit is used to house the electrical connections from the solar panels and/or the auxiliary electrical leads to the wide band lamp.

The current application claims a priority to the U.S. Provisional Patent application Ser. No. 61/878,215 filed on Sep. 16, 2013.

### FIELD OF THE INVENTION

The present invention generally relates to the field of lighting systems for super highways and interstate highways, both within the United States and internationally. More specifically, the present invention is an efficiently shaped apparatus that broadcasts pure white light in a radiating arc.

### BACKGROUND OF THE INVENTION

The traditional means of illuminating interstate and super highway systems in the United States and around the world is antiquated by being almost 60 years old. The majority of lighting presently employs a 40-foot or taller steel pole from which light falls onto the road surface in a circle that diminishes as the light radiates out from the center point of the circle. These poles are spaced an average of 150 feet apart that leaves wide areas of the road that are not fully illuminated. The majority of the light is diffracted by the air before it is able to reach the road, which is useless to a motorist.

An objective of the present invention is to illuminate the entire road surface in order to give the motorist a full “river of light” that makes far distance objects more visible. Thus, the present invention is more safe than the traditional sporadic lighting system.

The positioning of the bulbs allows the present invention to emit light in 170 degrees and 100 meters in any direction. The spacing of these bulbs allows the light from each bulb to overlap with each other and, thus, allows the present invention to fully illuminate a six-lane super highway and interstate highways, which can be up to 110 feet across. Therefore, the present invention allows lighting for every square foot of road surface.

### BRIEF DESCRIPTION OF THE DRAWINGS

FIG. 1 is a front view of the present invention.

FIG. 2 is a perspective view of the present invention.

FIG. 3 is a schematic side view of the present invention.

FIG. 4 is a magnified perspective view of a single illumination device for the present invention.

FIG. 5 is a schematic top view of the present invention, wherein the front side of the present invention illustrates internal component of the wide band lamp and the rear side of the present invention illustrates exterior of the wide band lamp.

FIG. 6 is a schematic top view of the present invention, wherein the front side and the rear side of the present invention illustrates exterior of the wide band lamp.

FIG. 7 is a schematic top view of the present invention, wherein the front side and the rear side of the present invention illustrates internal components of the wide band lamp.

FIG. 8A is a top schematic view of the plurality of illumination devices along the ellipsoid arc for the present invention.

FIG. 8B is a front schematic view of the plurality of illumination devices along the ellipsoid arc for the present invention.

FIG. 8A is a side schematic view of the plurality of illumination devices along the ellipsoid arc for the present invention.

### DETAILED DESCRIPTION OF THE INVENTION

All illustrations of the drawings are for the purpose of describing selected versions of the present invention and are not intended to limit the scope of the present invention.

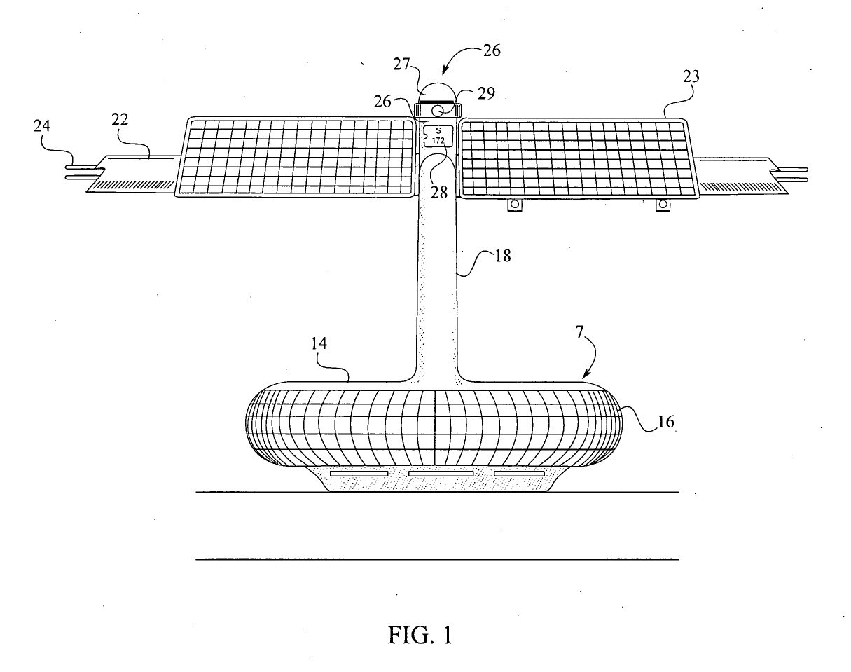

As can be seen in FIG. 1 through 3, the present invention is a road surface lighting apparatus that is used to illuminate the road surface area immediately surrounding the present invention. The present invention comprises a traffic barrier 1, at least on one wide band lamp 7, a horizontal conduit 22, a plurality of solar panels 23, and an at least one pair of auxiliary electrical leads 24. The traffic barrier 1 is used to situate the wide band lamp 7 on one particular portion along a road. In the preferred embodiment of the present invention, the traffic barrier 1 is a Jersey barrier, which is typically a heavy wall with a trapezoidal base. The traffic barrier 1 comprises a wall portion 2, which is used to divide traffic for some means, and a base portion 6, which is used to hold the wall portion 2 upright. In relation to each other, the wall portion 2 is positioned adjacent and along the base portion 6. The wide band lamp 7 allows the present invention to illuminate a larger surface area of the road. The plurality of solar panels 23 is used as the primary power source for the wide band arc, and the pair of auxiliary electrical leads 24 is used as a secondary power source if the plurality of solar panels 23 is not able to properly power the wide band lamp 7. The horizontal conduit 22 is used to house the electrical connection between these power sources and the wide band lamp 7.

The present invention is arranged in a general configuration so that these components are able to function more effectively and efficient with each other. The horizontal conduit 22 is mounted adjacent along the wall portion 2, opposite to the base portion 6, which allows the horizontal conduit 22 to position electrical connections between components anywhere along the wall portion 2. The wide band lamp 7 is mounted across the wall portion 2 in between the horizontal conduit 22 so that the wide band lamp 7 not focused on one part of the road and so that the light from the wide band lamp 7 is able to span the road. The plurality of solar panels 23 is mounted onto the horizontal conduit 22, opposite to the wall portion 2. Consequently, the plurality of solar panels 23 is positioned onto the highest point on the present invention and is not obstructed by any other components from the sunlight. Moreover, the plurality of solar panels 23 is permanently secured in order to prevent theft and vandalism of the plurality of solar panels 23. The dimensions for each of the plurality of solar panels 23 are determined by the required wattage for the wide band lamp 7. The plurality of solar panels 23 is also distributed along the horizontal conduit 22 so that the plurality of solar panels 23 does not obstruct each other from the sunlight. In the preferred embodiment of the present invention, each of the plurality of solar panels 23 is oriented at a 45-degree angle, in either direction, with the top surface 5 of the wall portion 2. In addition, the electrical connection between the plurality of solar panels 23 and the wide band lamp 7 traverse through the horizontal conduit 22 as a means to insulate this electrical connection and to protect this electrical connection from any external damage. Similarly, the electrical connection between the pair of auxiliary electrical leads 24 and the wide band lamp 7 traverses through the horizontal conduit 22 as a means to insulate this electrical connection and to protect this electrical connection from any external damage.

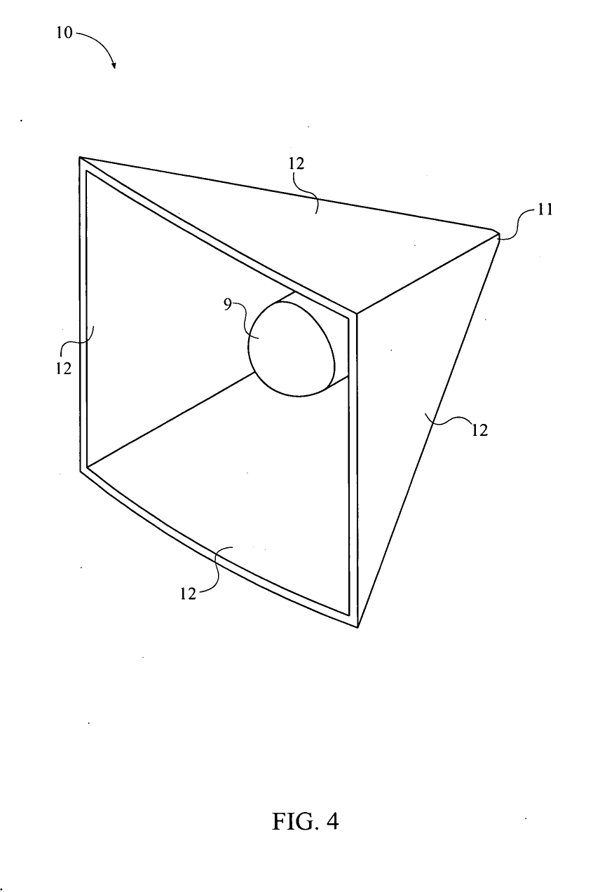

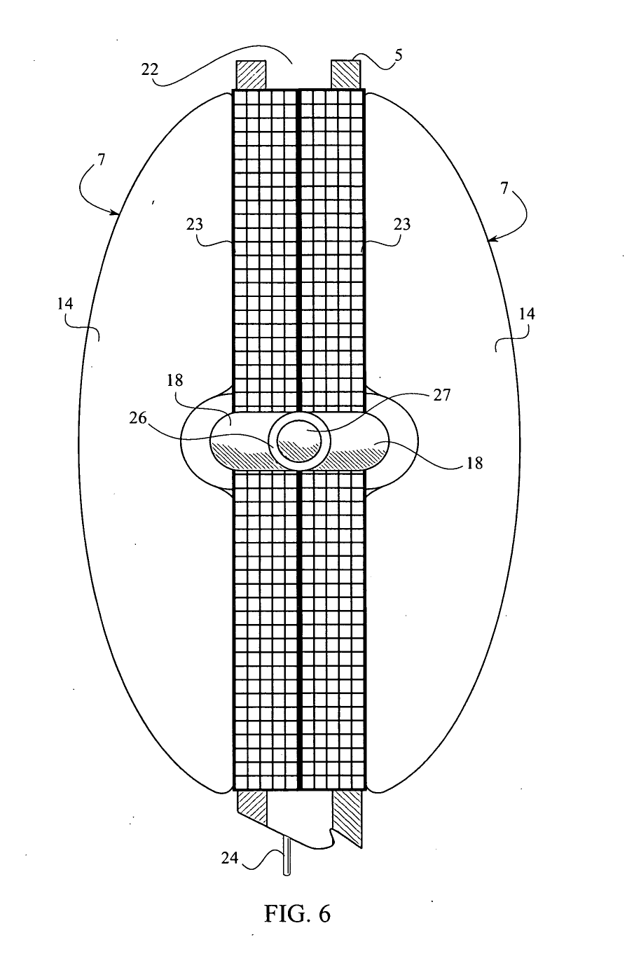

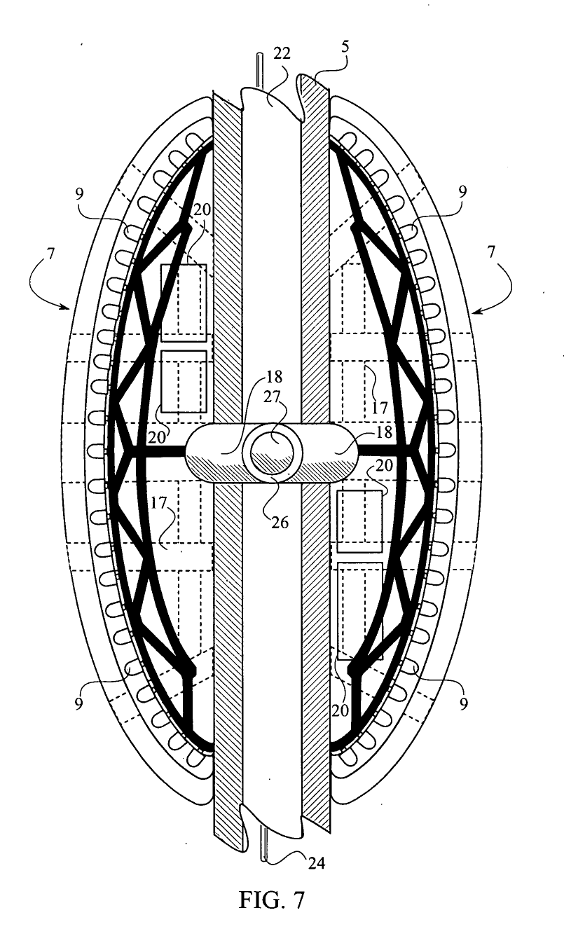

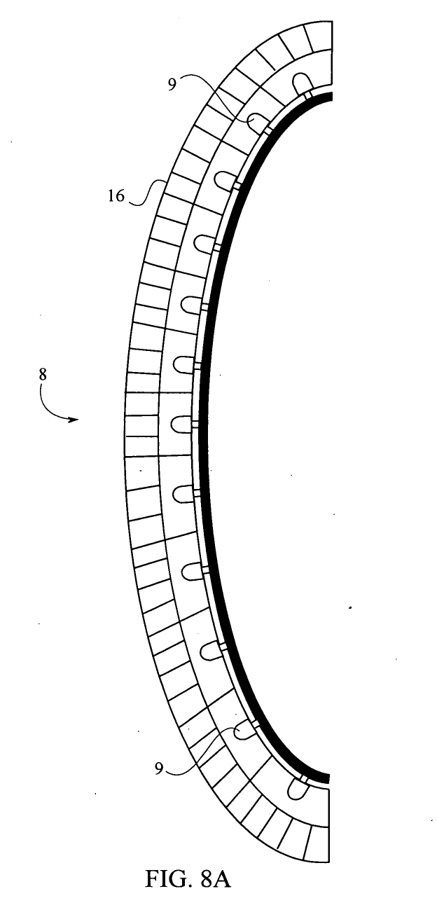

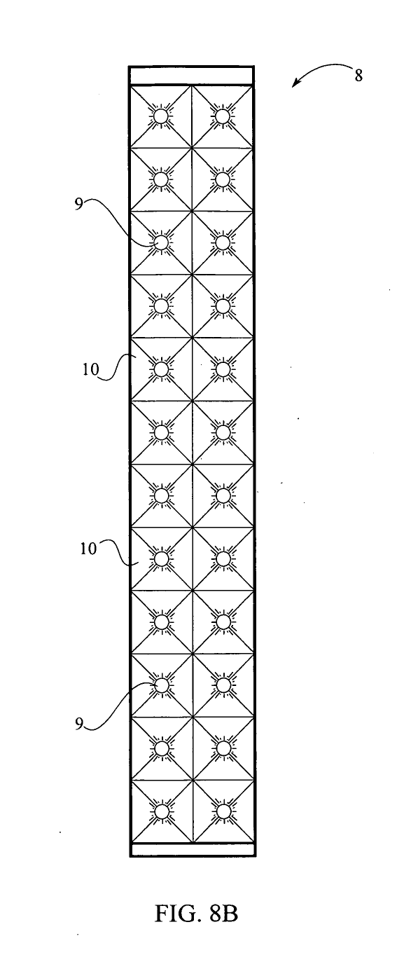

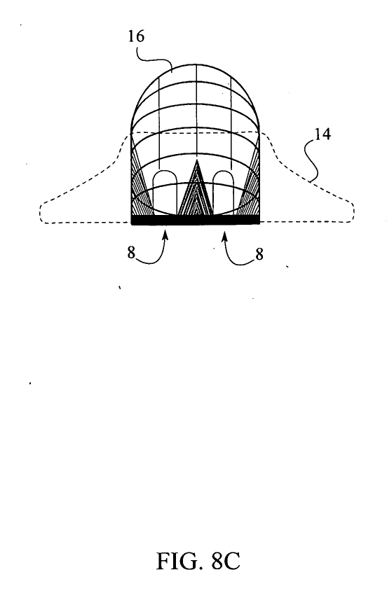

The wide band lamp 7 is preferably configured to radiate light in an arc of 170 degrees. Each of the at least one wide band lamp 7 comprises a plurality of illumination devices 8, a lamp housing 14, a viewing port 15, a support structure 17, a vertical conduit 18, and at least one rechargeable power storage unit 20, which are shown in FIG. 4 through 7. Each of the plurality of illumination devices 8 is capable of producing a single beam of light. As can be seen in FIG. 8A through 8C, the plurality of illumination devices 8 is physically separate objects and, thus, can be radially distributed along an ellipsoid arc 13. The ellipsoid arc 13 is positioned perpendicular and adjacent to the wall portion 2 in order to properly orient the plurality of illumination devices 8 towards the road. Each of the plurality of illumination devices 8 is mounted along the ellipsoid arc 13 by the support structure 17, which can be, but is not limited to, a steel frame. The rechargeable power storage unit 20 is used to store the collected energy from the plurality of solar panels 23. The rechargeable power storage unit 20 is mounted within the support structure 17 in order to maximize the space efficiency of present invention. The plurality of illumination devices 8, the support structure 17, and the rechargeable power storage unit 20 is positioned within the lamp housing 14 so that the lamp housing 14 is able to contain and protect these internal components from weather or other physical damage. The viewing port 15 is a hole that traverses out of the lamp housing 14, adjacent to the plurality of illumination devices 8, so that the light from the plurality of illumination devices 8 can travel through the lamp housing 14. The vertical conduit 18 is used to house electrical connections that travel from the horizontal conduit 22 into the lamp house. Consequently, the vertical conduit 18 traverses out of the horizontal conduit 22 and into the lamp housing 14.

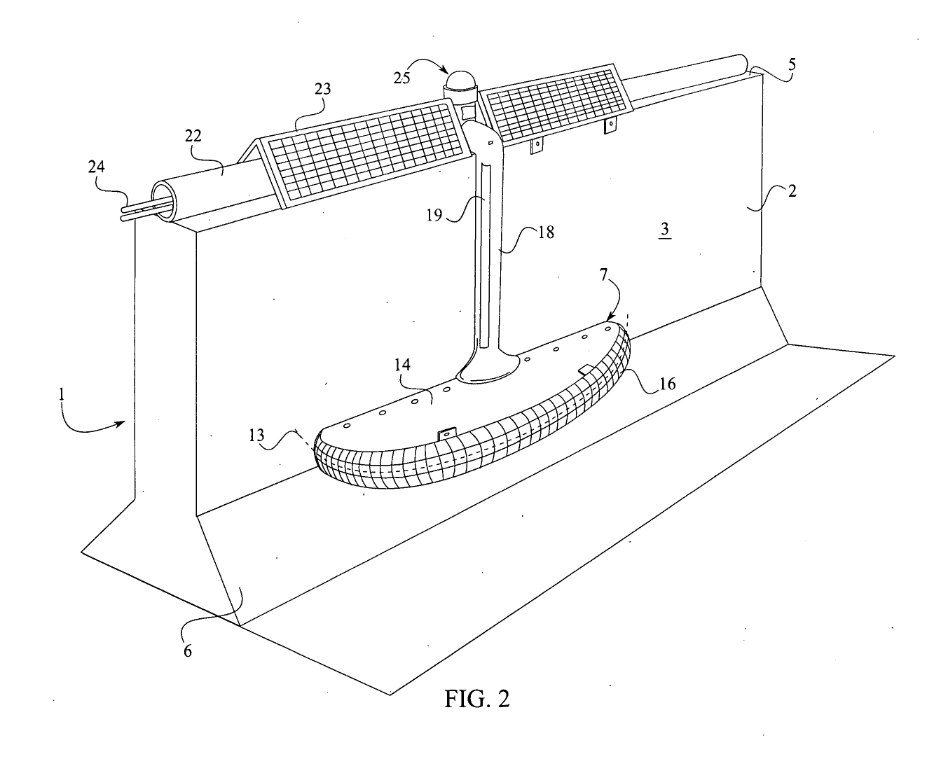

In the preferred embodiment of the present invention, the ellipsoid arc 13 has a specific orientation to the traffic barrier 1 and is shown in FIG. 2. The major axis of the ellipsoid arc 13 is positioned along the wall portion 2, parallel to the base portion 6, which allows the plurality of illumination devices 8 to be distributed along the length of the road. The minor axis of the ellipsoid arc 13 is positioned normal to the wall portion 2, which allows the plurality of illumination devices 8 to be oriented towards the road.

The electrical connections for the wide band lamp 7 allow electrical power to safely travel from their sources to their outputs. The plurality of solar panels 23 is electrically connected to the rechargeable power storage unit 20 through the horizontal conduit 22 and through the vertical conduit 18. During the daytime, this allows the plurality of solar panels 23 to convert sunlight into electrical power that can be stored within the rechargeable power storage unit 20. The rechargeable power storage unit 20 is electrically connected to the plurality of illumination devices 8. During the nighttime, this allows the rechargeable power storage unit 20 to continuously deliver electrical power to the plurality of illumination devices 8. If the rechargeable power storage unit 20 is not able to continuously deliver electrical power to the plurality of illumination devices 8, then the electrical power is delivered to the plurality of illumination devices 8 from the pair of auxiliary electrical leads 24 by an electrical connection that is made through the horizontal conduit 22 and the vertical conduit 18.

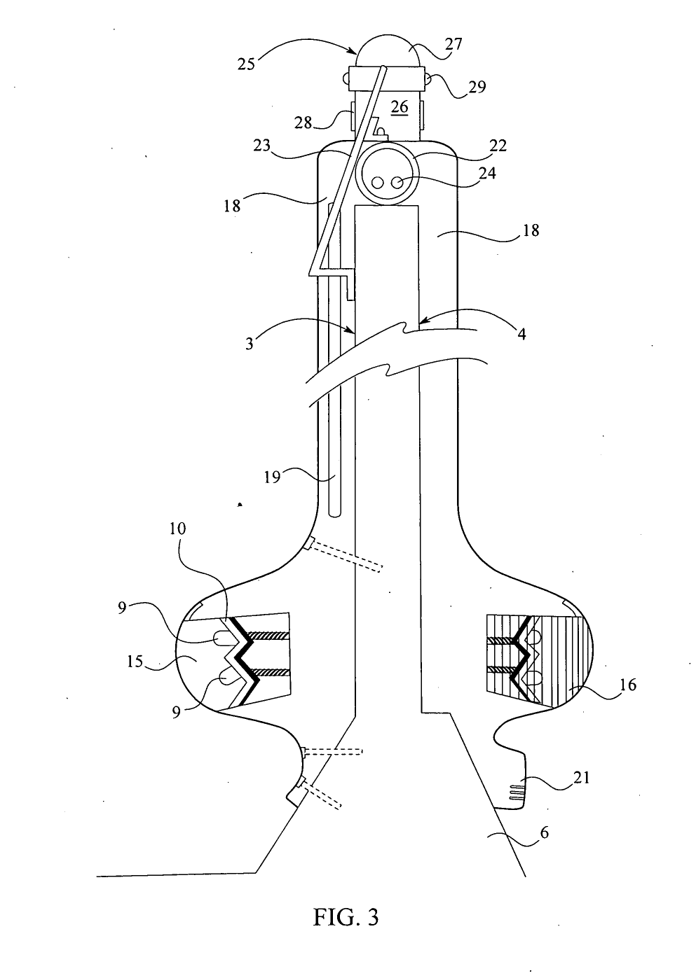

In some embodiments of the present invention, the wide band lamp 7 can include additional components that add ancillary functionalities to the present invention, which can be seen in FIG. 3. Each of the at least one wide band lamp 7 further comprises a transparent screen 16, a reflective strip 19, and a heater 21. The transparent screen 16 is used as a protective cover for the plurality of illumination devices 8, but most of the light emitted by the plurality of illumination devices 8 is still able to travel through the transparent screen 16. The transparent screen 16 can be, but is not limited to, a steel grid or a clear solid acrylic shield. The transparent screen 16 is perimetrically attached to the viewing port 15 so that the plurality of illumination devices 8 is completely enclosed between the transparent screen 16 and the lamp housing 14. The transparent screen 16 is also hinged connected to the lamp housing 14, preferably by piano hinges, so that the maintenance worker can open the transparent screen 16 and can access the internal components of the wide band lamp 7. Key-hole mechanisms can be used to selectively open and close the transparent screen 16. In addition, the reflective strip 19 allows the present invention to be more visible to a passing car. Consequently, the reflective strip 19 is externally mounted along the vertical conduit 18. Moreover, the heater 21 is used to melt snow accumulation that could obstruct the light emitted by the plurality of illumination devices 8. Thus, the heater 21 is externally mounted to the lamp housing 14, adjacent to the base portion 6, so that the snow accumulation is melted before it can obstruct the light from the plurality of illumination devices 8. The heater 21 also needs to be electrically connected to the rechargeable power storage unit 20 and the pair of auxiliary electrical leads 24 so that the heater 21 can receive electrical power from one of these sources. In the preferred embodiment the present invention, the heater 21 is a halogen heat lamp.

In the preferred embodiment of the present invention, the plurality of illumination devices 8 has a specific configuration in order to better position and orient the plurality of illumination devices 8 along the ellipsoid arc 13. Each of the plurality of illumination devices 8 comprises a light emitting diode (LED) bulb 9 and a pyramidal case 10, which is shown in FIG. 4. The LED bulb 9 is a low energy, efficiently sized device that is capable of producing the necessary light in one direction along the ellipsoid arc 13. The pyramidal case 10 is used to enclose and support the LED bulb 9 and is used as a reflector for the LED bulb 9, which focuses the light from the LED bulb 9 in one direction. The pyramidal case 10 comprises a plurality of lateral panels 12 that are positioned about an apex 11. The LED bulb 9 traverses into the pyramidal case 10 through the apex 11 so that the plurality of lateral panels 12 is radially positioned around the LED bulb 9. This allows the LED bulb 9 to be surrounded by the inner reflective surface for each lateral panel 12. The inner reflective surface can be, but is not limited to, a silver Mylar reflective shielding.

A multiple of the present invention is typically arranged in a series of units so that the series of units illuminates the entire length of the road. Thus, each unit further comprises an indicator assembly 25 that can be used to uniquely identify each unit's particular distance along the road. The indicator assembly 25 comprises an indicator housing 26, an indicator illumination device 27, and an indicator display 28. The indicator housing 26 is used to serve as a base for components of the indicator assembly 25 to be connected together. The indicator housing 26 is integrally mounted onto the horizontal conduit 22, adjacent to the wide band lamp 7, which allows the indicator illumination device 27 to be mounted into the indicator housing 26 opposite the horizontal conduit 22. This configuration between the indicator housing 26 and the indicator light allows the indicator light to be at the highest point of the present invention so that the indicator light is more visible to a passing car. The indicator illumination device 27 is also used to visually indicate the edge of the road, which is beneficial in inclement weather or heavy fog. The indicator display 28 is used to visually mark the particular distance of its unit and is externally mounted onto the indicator housing 26. In some embodiments of the present invention, the horizontal conduit 22, the vertical conduit 18, the indicator housing 26, and the lamp housing 14 are made of polyvinyl chloride (PVC).

As seen in FIGS. 1 and 3, series of units uniquely identifies interval units in order to notify a passing car that it has reached a particular distance. For example, the interval units could mark every mile along the length of the road and could flash a purple color instead of a yellow color. A telecommunication interface 29 could also be placed at each of these interval units so that someone in distress can run to one of the interval units and call for help. The telecommunication interface 29 can be, but is not limited to, just a call button or a telephone system with a speaker, a microphone, and a transceiver. The telecommunication interface 29 is mounted into the indicator assembly 25 of each interval unit so that the telecommunication interface 29 is easily accessible.

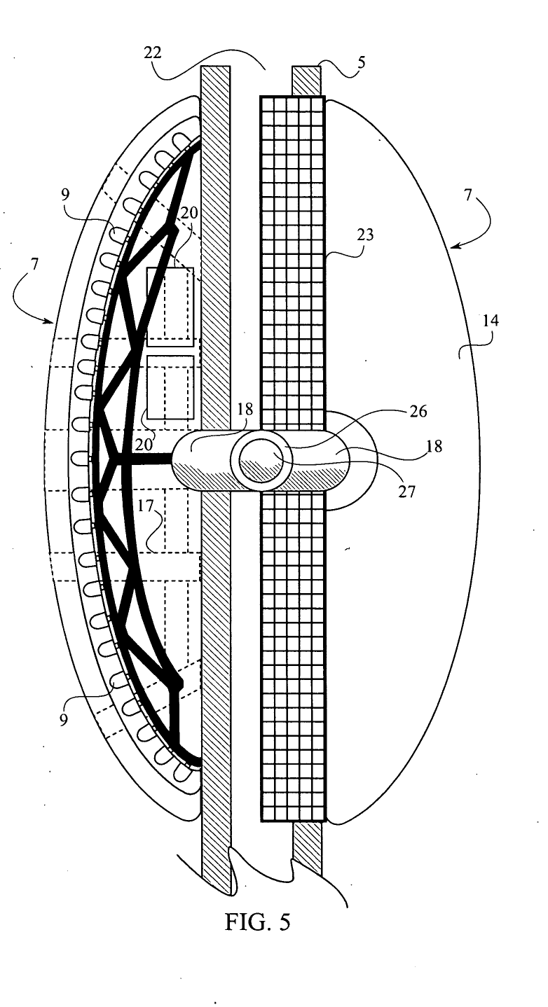

If the present invention implements one wide band lamp 7, then two of the present invention needs to be placed on opposing sides of the road. In this case, the wall portion 2 of one of the present invention could be coated in a reflective paint in order bounce the light coming from the wide band lamp 7 from another of the present invention on the other side of the road. Conversely, if the present invention implements two wide band lamps 7 as can be seen in FIG. 5 through 7, then only one of the present invention needs to be placed in the middle of the road. Thus, the at least one wide band lamp 7 could be a first lamp and a second lamp. In order to describe positioning of the first lamp and the second lamp, the wall portion 2 needs to comprises a first lengthwise surface 3 and a second lengthwise surface 4 that are parallel to each other and being positioned opposite to each other through the wall portion 2. Thus, the first lamp is mounted onto and oriented away from the first lengthwise surface 3 so that the first lamp can illuminate one side of the road. In addition, the second lamp is mounted onto and oriented away from the second lengthwise surface 4 so that the second lamp can illuminate other side of the road.

Although the invention has been explained in relation to its preferred embodiment, it is to be understood that many other possible modifications and variations can be made without departing from the spirit and scope of the invention as hereinafter claimed.

1. A road surface lighting apparatus comprises:
a traffic barrier;
at least one wide band lamp;
a plurality of solar panels;
a horizontal conduit;
at least one pair of auxiliary electrical leads;
said traffic barrier comprises a wall portion and a base portion;
said wall portion being positioned adjacent and along to said base portion;
said horizontal conduit being mounted adjacent and along said wall portion, opposite to said base portion;
said wide band lamp being mounted across said wall portion in between said horizontal conduit;
said plurality of solar panels being mounted onto said horizontal conduit, opposite to said wall portion;
said plurality of solar panels being distributed along said horizontal conduit;
said plurality of solar panels being electrically connected to said wide band lamp through said horizontal conduit; and
said pair of auxiliary electrical leads being electrically connected to said wide band lamp through said horizontal conduit.

2. The road surface lighting apparatus as claimed in claim 1 comprises:
each of said at least one wide band lamp comprises a plurality of illumination devices, a lamp housing, a viewing port, a support structure, a vertical conduit, and at least one rechargeable power storage unit;
an ellipsoid arc being positioned perpendicular and adjacent to said wall portion;
said plurality of illumination devices being radially distributed along said ellipsoid arc;
said plurality of illumination devices being mounted along said ellipsoid arc by said support structure;
said rechargeable power storage unit being mounted within said support structure;
said plurality of illumination devices, said support structure, and said rechargeable power storage unit being positioned within said lamp housing;
said viewing port traversing out of said lamp housing, adjacent to said plurality of illumination devices; and
said vertical conduit traversing out of said horizontal conduit and into said lamp housing.

3. The road surface lighting apparatus as claimed in claim 2 comprises:
a major axis of said ellipsoid arc being positioned along said wall portion, parallel to said base portion; and
a minor axis of said ellipsoid arc being positioned normal to said wall portion.

4. The road surface lighting apparatus as claimed in claim 2 comprises:
said plurality of solar panels being electrically connected to said rechargeable power storage unit through said horizontal conduit and through said vertical conduit;
said rechargeable power storage unit being electrically connected to said plurality of illumination devices; and
said pair of auxiliary electrical leads being electrically connected to said plurality of through said horizontal conduit and through said vertical conduit.

5. The road surface lighting apparatus as claimed in claim 2 comprises:
each of said at least one wide band lamp further comprises a transparent screen;
said transparent screen being perimetrically attached to said viewing port; and
said transparent screen being hingedly connected to said lamping housing.

6. The road surface lighting apparatus as claimed in claim 2 comprises:
each of said at least one wide band lamp further comprises a reflective strip; and
said reflective strip being externally mounted along said vertical conduit.

7. The road surface lighting apparatus as claimed in claim 2 comprises:
each of said at least one wide band lamp further comprises a heater;
said heater being externally mounted to said lamp housing, adjacent to said base portion; and
said heater being electrically connected to said rechargeable power storage unit and said pair of auxiliary electrical leads.

8. The road surface lighting apparatus as claimed in claim 2 comprises:
each of said plurality of illumination devices comprises a light emitting diode (LED) bulb and a pyramidal case;
said pyramidal case comprises an apex and a plurality of lateral panels;
each of said plurality of lateral panels comprises an inner reflective surface;
said plurality of lateral panels being positioned about said apex;
said LED bulb traversing into said pyramidal case through said apex; and
said LED bulb being surrounded by said inner reflective surface for each of said plurality of lateral panels.

9. The road surface lighting apparatus as claimed in claim 1 comprises:
an indicator assembly;
said indicator assembly comprises an indicator housing, an indicator illumination device, and an indicator display;
said indicator housing being integrally mounted onto said horizontal conduit, adjacent to said wide band lamp;
said indicator illumination device being mounted into said indicator housing, opposite to said horizontal conduit; and
said indicator display being externally mounted onto said indicator housing.

10. The road surface lighting apparatus as claimed in claim 1 comprises:
a telecommunication interface; and
said telecommunication interface being mounted into an indicator assembly.

11. The road surface lighting apparatus as claimed in claim 1 comprises:
said at least one wide band lamp comprises a first lamp and a second lamp;
said wall portion comprises a first lengthwise surface and a second lengthwise surface;
said first lengthwise surface and said second lengthwise surface being parallel to each other and being positioned opposite to each other through said wall portion;
said first lamp being mounted onto said first lengthwise surface;
said first lamp being oriented away from said first lengthwise surface;
said second lamp being mounted onto said second lengthwise surface; and
said second lamp being mounted away said second lengthwise surface.

12. A road surface lighting apparatus comprises:
a traffic barrier;
at least one wide band lamp;
a plurality of solar panels;
a horizontal conduit;
at least one pair of auxiliary electrical leads;
each of said at least one wide band lamp comprises a plurality of illumination devices, a lamp housing, a viewing port, a support structure, a vertical conduit, and at least one rechargeable power storage unit;
said traffic barrier comprises a wall portion and a base portion;
said wall portion being positioned adjacent and along to said base portion;
said horizontal conduit being mounted adjacent and along said wall portion, opposite to said base portion;
said wide band lamp being mounted across said wall portion in between said horizontal conduit;
said plurality of solar panels being mounted onto said horizontal conduit, opposite to said wall portion;
said plurality of solar panels being distributed along said horizontal conduit;
said plurality of solar panels being electrically connected to said wide band lamp through said horizontal conduit;
said pair of auxiliary electrical leads being electrically connected to said wide band lamp through said horizontal conduit;
an ellipsoid arc being positioned perpendicular and adjacent to said wall portion;
said plurality of illumination devices being radially distributed along said ellipsoid arc;
said plurality of illumination devices being mounted along said ellipsoid arc by said support structure;
said rechargeable power storage unit being mounted within said support structure;
said plurality of illumination devices, said support structure, and said rechargeable power storage unit being positioned within said lamp housing;
said viewing port traversing out of said lamp housing, adjacent to said plurality of illumination devices; and
said vertical conduit traversing out of said horizontal conduit and into said lamp housing.

13. The road surface lighting apparatus as claimed in claim 12 comprises:
a major axis of said ellipsoid arc being positioned along said wall portion, parallel to said base portion; and
a minor axis of said ellipsoid arc being positioned normal to said wall portion.

14. The road surface lighting apparatus as claimed in claim 12 comprises:
said plurality of solar panels being electrically connected to said rechargeable power storage unit through said horizontal conduit and through said vertical conduit;
said rechargeable power storage unit being electrically connected to said plurality of illumination devices; and
said pair of auxiliary electrical leads being electrically connected to said plurality of through said horizontal conduit and through said vertical conduit.

15. The road surface lighting apparatus as claimed in claim 12 comprises:
each of said at least one wide band lamp further comprises a transparent screen;
said transparent screen being perimetrically attached to said viewing port; and
said transparent screen being hingedly connected to said lamping housing.

16. The road surface lighting apparatus as claimed in claim 12 comprises:
each of said at least one wide band lamp further comprises a reflective strip; and
said reflective strip being externally mounted along said vertical conduit.

17. The road surface lighting apparatus as claimed in claim 12 comprises:
each of said at least one wide band lamp further comprises a heater;
said heater being externally mounted to said lamp housing, adjacent to said base portion; and
said heater being electrically connected to said rechargeable power storage unit and said pair of auxiliary electrical leads.

18. The road surface lighting apparatus as claimed in claim 12 comprises:
each of said plurality of illumination devices comprises a light emitting diode (LED) bulb and a pyramidal case;
said pyramidal case comprises an apex and a plurality of lateral panels;
each of said plurality of lateral panels comprises an inner reflective surface;
said plurality of lateral panels being positioned about said apex;
said LED bulb traversing into said pyramidal case through said apex; and
said LED bulb being surrounded by said inner reflective surface for each of said plurality of lateral panels.

19. The road surface lighting apparatus as claimed in claim 12 comprises:
an indicator assembly;
a telecommunication interface;
said indicator assembly comprises an indicator housing, an indicator illumination device, and an indicator display;
said indicator housing being integrally mounted onto said horizontal conduit, adjacent to said wide band lamp;
said indicator illumination device being mounted into said indicator housing, opposite to said horizontal conduit;
said indicator display being externally mounted onto said indicator housing; and
said telecommunication interface being mounted into an indicator assembly.

20. The road surface lighting apparatus as claimed in claim 12 comprises:
said at least one wide band lamp comprises a first lamp and a second lamp;
said wall portion comprises a first lengthwise surface and a second lengthwise surface;
said first lengthwise surface and said second lengthwise surface being parallel to each other and being positioned opposite to each other through said wall portion;
said first lamp being mounted onto said first lengthwise surface;
said first lamp being oriented away from said first lengthwise surface;
said second lamp being mounted onto said second lengthwise surface; and
said second lamp being mounted away said second lengthwise surface.
